(19) United States
(12) Patent Application Publication
(10) Pub. No.: US 2024/0073985 A1
(43) Pub. Date: Feb. 29, 2024

(54) METHODS, DEVICES AND SYSTEMS FOR BEAM FAILURE RECOVERY

(71) Applicant: ZTE CORPORATION, Shenzhen (CN)

(72) Inventors: Meng MEI, Shenzhen (CN); Chuangxin JIANG, Shenzhen (CN); Zhaohua LU, Shenzhen (CN); Shujuan ZHANG, Shenzhen (CN); Bo GAO, Shenzhen (CN); Yang ZHANG, Shenzhen (CN)

(73) Assignee: ZTE CORPORATION, Shenzhen (CN)

(21) Appl. No.: 18/505,657

(22) Filed: Nov. 9, 2023

Related U.S. Application Data
(63) Continuation of application No. PCT/CN21/92965, filed on May 11, 2021.

(51) Int. Cl. H04W 76/19; H04L 5/00

(52) U.S. Cl. CPC H04W 76/19; H04L 5/0053; H04L 5/0094

(57) ABSTRACT

A system, device and method for failure recovery is disclosed. In one aspect, a method includes determining, by a wireless communication device, at least one reference signal of at least one transmission configuration indicator (TCI) state for beam failure detection, from reference signals of a control resource set (CORESET); and determining, by the wireless communication device according to the at least one reference signal, at least one measurement for comparison with a threshold.

### CROSS-REFERENCE TO RELATED APPLICATIONS

This application claims the benefit of priority under 35 U.S.C. § 120 as a continuation of PCT Patent Application No. PCT/CN2021/092965, filed on May 11, 2021, the disclosure of which is incorporated herein by reference in its entirety.

### TECHNICAL FIELD

The disclosure relates generally to wireless communications and, more particularly, to systems and methods for adding new beam(s) and/or beam failure recovery.

### BACKGROUND

In a single frequency network (SFN) scenario, two transmission reception points (TRPs) transmit same information to one user equipment (UE), but in a high speed train (HST)-SFN scenario for instance, the UE moves from one TRP to the other TRP causing Doppler effects such that a first Doppler effect with respect to one TRP may be opposite of a second Doppler effect with respect to the other TRP.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In some aspects, a system, device and method for beam failure recovery (e.g., in a SFN scenario) is disclosed. In one aspect, a method includes determining, by a wireless communication device, at least one reference signal of at least one transmission configuration indicator (TCI) state for beam failure detection, from reference signals of a control resource set (CORESET); and determining, by the wireless communication device according to the at least one reference signal, at least one measurement for comparison with a threshold.

In some embodiments, the measurement includes at least one of a block error rate (BLER), or a reference signal received power (RSRP), or a signal-to-interference and noise ratio (SINR). In some embodiments, the at least one reference signal determined for beam failure detection includes reference signals of the two TCI states, and the at least one measurement includes at least one of an individual measurement or a combined measurement.

In some embodiments, the at least one reference signal determined for beam failure detection includes one reference signal of one of the two (e.g., activated) TCI states that has a higher RSRP or SINR than another one of the other one of the two TCI states, includes quasi co-location (QCL) assumption of Doppler shift or delay information, is configured via radio resource control (RRC) or medium access control control element (MAC CE) signaling for beam failure detection, or is predetermined from a default TCI state for beam failure detection.

In some aspects, a system, device and method for introducing or adding at least one new beam (e.g., in a SFN scenario) is disclosed. In one aspect, a method includes receiving, by a wireless communication device, a number of candidate beams; and reporting, by the wireless communication device to a wireless communication node, at least one new beam. In some embodiments, the at least one new beam is associated with at least one reference signal resource or reference signal resource set.

In some embodiments, a number of beam pairs to be measured (N) is configured via radio resource control (RRC) signaling, and formed from 2N number of the candidate beams, and remainder of the candidate beams are to be individually measured. In some embodiments, the method includes reporting, by the wireless communication device to the wireless communication node, two new beams as a beam pair.

In some embodiments, each link or control resource set (CORESET) after beam failure recovery uses the two new beams regardless of whether the respective CORESET supports two transmission configuration indicator (TCI) states prior to the beam failure recovery, or each CORESET having two TCI states prior to the beam failure recovery, can use the two new beams after the beam failure recovery, and each CORESET having one TCI state prior to the beam failure recovery, can use one of the two new beams after the beam failure recovery, or a CORESET for linking to a SSS, uses the two new beams.

In certain aspects, a system, device and method for using using TCI state(s) on physical uplink transmission(s) is disclosed. In one aspect, a method includes, if a first control resource set (CORESET) with a lowest index is activated with two transmission configuration indicator (TCI) states, and two groups of physical uplink transmissions are configured, using, by a wireless communication device, the two TCI states of the first CORESET on different ones of the two groups of physical uplink transmissions.

In some aspects, another system, device and method for introducing or adding at least one new beam is disclosed. In one aspect, a method includes sending, by a wireless communication node to a wireless communication device, a number of candidate beams; and receiving, by the wireless communication node from the wireless communication device, at least one new beam

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques and other aspects disclosed herein may be implemented, in accordance with an embodiment of the present disclosure.

FIG. 2 illustrates block diagrams of an example base station and a user equipment device, in accordance with some embodiments of the present disclosure.

FIG. 3 illustrates an example diagram of cyclic mapping for a PUCCH transmission, in accordance with some embodiments of the present disclosure.

FIG. 4 illustrates an example diagram of sequence mapping for a PUCCH transmission, in accordance with some embodiments of the present disclosure.

FIG. 5 illustrates an example diagram of half-half mapping for a PUCCH transmission, in accordance with some embodiments of the present disclosure.

FIG. 6 illustrates a flowchart diagram of a method for beam failure recovery, in accordance with some embodiments of the present disclosure.

FIG. 7 illustrates a flowchart diagram of a method for introducing or adding new beam(s), in accordance with some embodiments of the present disclosure.

FIG. 8 illustrates a flowchart diagram of a method for using TCI state(s) on uplink transmission(s), in accordance with some embodiments of the present disclosure.

FIG. 9 illustrates a flowchart diagram of a method for introducing or adding new beam(s), in accordance with some embodiments of the present disclosure.

### DETAILED DESCRIPTION OF EXAMPLE EMBODIMENTS

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### A. Network Environment and Computing Environment

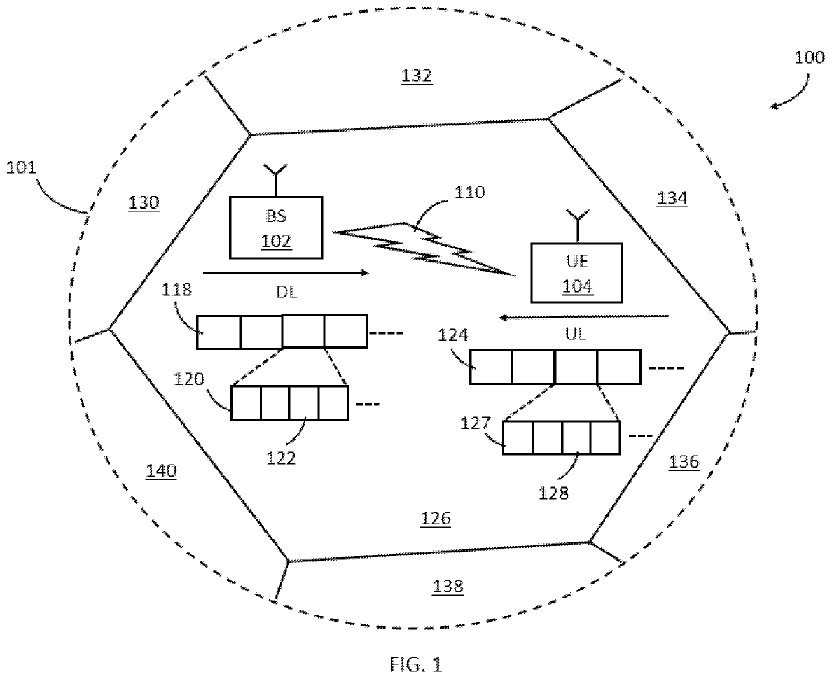

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and the UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and the UE 104 are described herein as non-limiting examples of “communication nodes,” generally, which can practice the methods disclosed herein. Such communication nodes may be capable of wireless and/or wired communications, in accordance with various embodiments of the present solution.

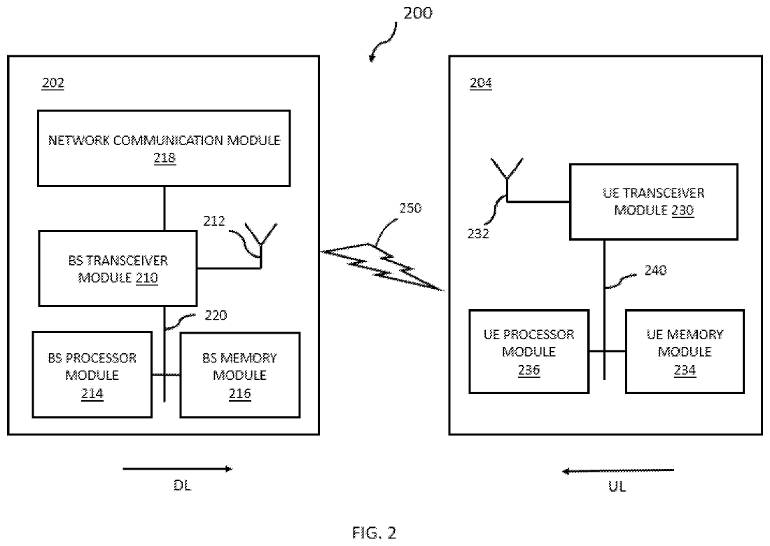

FIG. 2 illustrates a block diagram of an example wireless communication system 200 for transmitting and receiving wireless communication signals, e.g., OFDM/OFDMA signals, in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a the UE (user equipment) transceiver module 230, a the UE antenna 232, a the UE memory module 234, and a the UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

### B. Systems and Methods for Beam Management

In a single frequency network (SFN) scenario, one CORESET can be activated with two transmission configuration information (TCI) states. In embodiments, up to three control resource sets (CORESETs) can be configured for one activated bandwidth part (BWP), one/each CORESET is activated with one TCI state and associated with one reference signal (RS), and up to two RS indices can be detected to find whether the beam of this transmission has failed and is to be recovered. If two TCI states are activated for one/each CORESET, there may be up to four RSs indexed for the beam detection. Disclosed herein are embodiments system, device, and method for how to use up to the four (e.g., or other various numbers of) RSs, that may be indexed to perform beam failure recovery and/or other operations.

Prior to triggering beam failure recovery, some reference signal resources or resource sets can be detected. For embodiments lacking the disclosed improvements, up to two RSs of the configured or activated CORESET can be detected and the estimation/measurement results can be compared with a threshold to find out whether the beam detection has failed and that beam failure recovery is to be initiated.

Quality-out (Qout) and quality-in (Qin) are quality measures/thresholds. In some embodiments, Qout is defined as the level at which a downlink (DL) radio link cannot be reliably received and includes or corresponds to an out-of-sync block error rate (BLERout). For single sideband (SSB)-based radio link monitoring, Qout_SSB can be derived based on hypothetical physical downlink control channel (PDCCH) transmission parameters. For channel state indicator (CSI)-RS-based radio link monitoring, Qout_CSI-RS is derived based on the hypothetical PDCCH transmission parameters.

In some embodiments, the threshold Qin is defined as the level at which the DL link quality can be received with (e.g., significantly) higher reliability than at Qout and includes or corresponds to an in-sync block error rate (BLERin). For single SSB-based radio link monitoring, Qin_SSB can be derived based on the hypothetical PDCCH transmission parameters. For CSI-RS based radio link monitoring, Qin_CSI-RS is derived based on the hypothetical PDCCH transmission parameters.

The BLERin and BLERout can be determined from the network configuration via a parameter signaled by higher layers. When user equipment (a UE, e.g., the UE 104, the UE 204, a mobile device, a wireless communication device, a terminal, etc.) is not configured with the threshold from the network (e.g., a 5G network, a core network (CN), a radio access network (RAN), a combination of the CN and the RAN, etc.), the UE can determine the BLERin and BLERout by default. In some embodiments, the radio access network covers a geographical area which is divided into cell areas, with each cell area being served by a base station (BS, e.g., the BS 102, the BS 202, a next generation NodeB (gNB), an evolved NodeB (eNB), a wireless communication node, a cell tower, a 3GPP radio access device, a non-3GPP radio access device, etc.). It should be noted that BLER measurements are referrer to in this disclosure only by way of example, and are not intended to be limiting in any way. Other types of measurements (e.g., RSRP or SINR) can also apply (e.g., in placed of BLER) in various implementations.

In the SFN scenario, one CORESET can be activated with two TCI states. Disclosed herein are embodiments of system, device, and method for how to manage or respond to the beam failure recovery with two activated TCI states for one CORESET.

In some embodiments, one rule is defined to detect one TCI state (or RS) of a CORESET activated with two TCI states. The TCI state or related RS with a higher reference signal received power (RSRP) or signal-to-inference and noise ratio (SINR) can be used as the detection RS for the beam failure detection. In some embodiments, the TCI state that contains a quasi co-location (QCL) assumption of Doppler shift is used as the TCI state to e detected, and the RS in this TCI state is used as the RS to be detected for beam failure detection. Radio resource control (RRC) signaling can configure one of the two TCI states to be used for beam failure detection. One of the two TCI states can be configured by default (e.g., preconfigured, preprogrammed) for beam failure detection.

In some embodiments, both of the RSs in the two TCI states activated for one CORESET are used for beam failure detection, and one combined BLER is used to compare with the threshold. The combined BLER can include the smaller BLER, the mean BLER of the two RSs, or the weighted BLER (e.g., weighted combination of individual BLERs) of the two RSs. The weight of each BLER can be based on (e.g., a ratio of) the RSRP or SINR of the RS associated with the respective TCI state. RRC signaling can configure whether to use individual BLER(s) and/or a combined BLER.

In some embodiments, the number of beam pairs is configured by RRC, the former/first 2N candidate beams are measured as pairs and the other beams are individual candidate beams (to be measured individually). In some embodiments, if only one new beam is indicated or reported, a PDCCH is transmitted in a non-SFN manner. In some embodiments, if two beams are indicated, all of the recovered link or CORESET(s) can use the two beams irrespective/regardless of whether two TCI states containing QCL type-D are supported for one/each CORESET (or irrespective of whether the CORESETs support SFN prior to beam failure recovery).

In some embodiments, a CORESET with two activated TCI states before beam failure (e.g., the CORESET receives/obtains/generates/activates/includes/corresponds to the two activated TCI states before beam failure) can use the two indicated new beams or new beam pair, and a CORESET with only one activated TCI state before beam failure can use (only) one of the indicated new beam or new beam pair, and the number of new beams is associated with the CORESET index (ID).

In some embodiments, one (e.g., best, higher than a predetermined threshold, etc.) beam pair and one (e.g., best, higher than a predetermined threshold, etc.) individual beam is reported or indicated. In some embodiments, a CORESET with two activated beams before beam failure uses the reported or indicated beam pair. In some embodiments, the individual beam is used for a CORESET activated with one beam before beam failure. In some embodiments, a CORESET through a link to a SSS provided by recoverySearchSpaceId for monitoring PDCCH in the CORESET, is used to monitor a SFN-based PDCCH transmission(s).

In some embodiments, if the CORESET with a lowest index is activated with two TCI states and physical uplink control channel (PUCCH) repetition is supported in the UL transmission, the two TCI states of the CORESET with the lowest index is used on different PUCCH transmission occasions. In some embodiments, for default TCI states for PUCCH repetition transmissions, the lowest indexed CORESET is activated with two TCI states. In some embodiments, default TCI states for PUCCH repetition are from a CORESET with the lowest index that is activated with two TCI states.

For beam failure detection (BFD), there may be several BLER calculation assumptions, e.g., a single TCI state specific calculation or a SFN (e.g., 2 TCI state specific) assumption. In some embodiments, the assumptions are associated with one CORESET.

For the single TCI state specific calculation, in some embodiments, the beam failure detection is based on a single TCI state of one CORESET. Up to two RS indices can be detected and a BLER is calculated based on each RS individually. In some embodiments, each of the RS indices represents one RS resource or one RS resource set. In some embodiments, for the SFN-based BLER calculation assumption, a BLER is calculated/determined for the combination of the RS pair. The beam failure detection can be associated with one CORESET. In some embodiments, if the CORESET is activated with only one TCI state, the BLER assumption is for a single TCI state, and the BLER is calculated based on one RS for each RS index. In some embodiments, if the CORESET is activated with two TCI states, the BLER calculation assumption is for two RSs from the two TCI states, and one combined BLER is determined/calculated for the beam failure detection.

Table 1.1 shows the PDCCH transmission parameters for beam failure detection. The BLER calculation for the beam failure detection can also be indicated by the PDCCH transmission parameters for beam failure detection. One PDCCH transmission scheme can be configured in the PDCCH transmission parameters as shown in Table 1.1.

TABLE 1.1

| Attribute | Value for BLER |
|---|---|
| DCI format | 1-0 |
| Number of control OFDM symbols | 2 |
| Aggregation level (number of | 8 |
| control channel elements (CCEs)) | |
| Ratio of hypothetical PDCCH RE energy to | 0 dB |
| average SSS RE energy | |
| Ratio of hypothetical PDCCH DMRS energy | 0 dB |
| to average SSS RE energy | |
| Bandwidth (number of physical resource | 24 |
| blocks (PRBs)) | |
| Sub-carrier spacing (SCS) (kHz) | Same as the SCS of |
| | remaining minimum |
| | system information |
| | (RMSI) CORESET |
| DMRS precoder granularity | REG bundle size |
| Resource element group (REG) bundle size | 6 |
| Cyclic prefix (CP) length | Normal |
| Mapping from REG to CCE | Distributed |
| Transmission scheme | SFN |

In some embodiments, the parameters are configured for a single TCI-based PDCCH transmission or a SFN-based BLER calculation. In some embodiments, the parameters for a BLER calculated by one TCI state or a combined BLER calculated for two TCI states can be used to indicate different BLER assumptions or BLER calculation methods by (e.g., the parameters) being configured with different values. For example, in some embodiments, a ratio of hypothetical PDCCH resource element (RE) energy or a PDCCH demodulation reference signal (DMRS) energy to an average search space set (SSS) RE energy is set to 0 dB for one BLER assumption (e.g., a single TCI-based BLER calculation), and 3 dB for another BLER assumption (e.g., a combined BLER calculation for SFN based PDCCH transmission).

For a new beam (or beam state or TCI state) indication, a number of new beams can be associated with the CORESET, and beam-CORESET association can be a unified association with the beam failure detection. For example, in some embodiments, if the BLER is calculated for one TCI state, the number of new beams is indicated as one, and if the BLER is calculated as a combined BLER, the number of new beams can be indicated as two.

For a new beam indication, the number of new beams can be indicated according to the PDCCH transmission parameters if PDCCH is configured as an SFN or time-division multiplexing (TDM)-based repetition, or if other parameters indicate that two new beams are needed. The UE can report one or two (new) beams based on the parameters or the UE measurement results. For example, the UE can report two beams for the SFN scheme and the TDM scheme, and if two beams are indicated, the two beams can be used for the transmission. In some embodiments, for the TDM scheme, the two beams are used for different PDCCH transmission occasions. But, in some embodiments, if the UE cannot find/detect/determine two (new) beams based on the new beam indication, then only one (new) beam can be reported, and the PDCCH or a physical downlink shared channel (PDSCH) can be transmitted by using one beam or one TCI state.

In some embodiments, a rule is defined to detect (for beam failure detection process) one TCI state (or RS) of the CORESET activated with two TCI states. The RSRP or SINR of the RS configured in the TCI states can be measured by the UE. Thus, if two TCI states are activated for one CORESET, the RSRP or SINR of each RS in the TCI state can be known/determined/identified by the UE. Thus, in some embodiments, the UE determines which TCI state can be detected according to the (e.g., estimated, predicted or measured) RSRP or SINR of each TCI state.

The TCI state (or RS) with a smaller or larger RSRP or SINR, or the RS of QCL-TypeD (from RSs of different QCL-Types), can be selected for beam failure detection. The higher RSRP or SINR can enable better estimation of the signal. Thus, the TCI state or related RS with the higher RSRP or SINR (e.g., layer 1 (L1)-RSRP, LI-SINR) can be used as the detection RS for the beam failure detection (BFD). Irrespective of whether the other detected RS is from the CORESET activated for one TCI state or two TCI states, the detected RS of the two RSs can be used for beam failure detection. In some embodiments, if the two RSs are detected to be higher than the threshold configured by higher layer, the counter increments (e.g., by one, towards a triggering threshold value for instance) until the UE decides to recover the beam, e.g., for new beam indication.

In a case that pre-compensation is configured/provided, the QCL assumptions are different and can be used by the UE. Thus, in some embodiments, only one TCI state of the two TCI states activated for PDCCH or indicated for PDSCH contains a Doppler shift. Thus, in some embodiments, the TCI state that contains the QCL assumption of Doppler shift or delay information (e.g., the TCI state that is used to estimate Doppler shift or delay information) is used as the detection TCI state (e.g., TCI state to be detected) for BFD, and the RS in this TCI state is used as the detection RS (e.g., RS to be detected) for beam failure detection. In some embodiments, if both the configured TCI states contain a Doppler shift, then one of the TCI states that contains a first Doppler shift is indicated or configured to be used, and a second Doppler shift contained in the other TCI state is ignored. It can be known by the UE which one of the two TCI states contains the Doppler shift.

In some embodiments, RRC and/or a medium access control (MAC) control element (CE) signaling can configure one of the two TCI states to be used for beam failure detection. For example, the RRC/MAC CE can configure that the first one of the two TCI states is used for beam failure detection. Similarly, the first or the second one of the activated (e.g., activated by MAC CE, from those configured by RRC) two TCI states of the CORESET can be selected, by default, to be used for beam failure detection.

One TCI state from one CORESET can be used for beam failure detection, and up to two RSs are supported. But, if one CORESET is activated for two TCI states, the other CORESET with only one TCI state can be used for beam failure detection. Alternatively, in some embodiments, if two TCI states are activated for one CORESET, the two TCI states of this CORESET can be used for beam failure detection and the TCI states of other CORESETs are not considered.

In some embodiments, both of the RSs in the two TCI states activated for one CORESET are used for beam failure detection, and one combined BLER is used to compare with (or against) the threshold. The RSs of the respective two TCI states can be measured, and the combined BLER can be achieved from one RS corresponding to the smaller BLER, the mean/average BLER of the two RSs, or the weighted BLER of the two RSs. The weight of each BLER can be achieved from the RSRP or SINR of the RS associated with each TCI state. For example, in some embodiments, if the RSRP or SINR of the two RSs are the same, the weighted BLER equals the mean BLER.

In some embodiments, the BLER can be calculated from the two RS indices, and the RSs from all the TCI states of the detected CORESET are considered as being from the two TCI states from one CORESET activated with two TCI states. In some embodiments, the RSs are selected from the TCI states according to an order of CORESET IDs (e.g., select from a lowest CORESET ID). For example, the RS with the CORESET with lowest index are selected first. In some embodiments, the RSs are selected according to the period size/value of the CSI-RSs/SSBs of the TCI states of the CORESETs. For example, the RS with the minimum period of the CSI-RSs/SSBs of the TCI states of the detected CORESETs is selected first.

The two BLERs can be treated/compared individually. Each of the two BLERs can be compared with the threshold, and if both of the two BLERs are higher than the threshold, the result (e.g., the BLERs) is reported to the gNB. In some embodiments, each of the individual BLER of the two RSs and the combined BLER are (each) compared with the threshold, and if all the three BLERs are higher than the threshold, the result (e.g., individual BLERs and the combined BLER) is reported to the gNB. The individual BLER or combined BLER can be used as the default or pre-defined. For example, only one of the two methods may be configured or pre-defined to be supported for the beam failure detection.

RRC signaling can be used to configure the type of BLER that is used as beam failure recovery. In some embodiments, if ‘0’ is configured via RRC, then the individual BLER is used as the beam failure recovery, and if ‘1’ is configured via RRC, then the combined BLER is used for beam failure recovery for instance.

All of the RSs can be detected individually, e.g., if two TCI states are activated for one CORESET, up to four RSs are supported to be detected. The threshold can be extended to be associated with each of the RSs. For example, if all of the detected RSs are measured with a BLER larger than the threshold, the UE can report the beam failure. In some embodiments, if one CORESET is activated with two TCI states and the other TCI states are activated with one TCI state, then each of the three RSs associated with a respective one of the three TCI states is measured individually.

If the beam measurement results in failure according the UE reporting and the gNB counting, then at least one more beam is measured and one new beam is indicated to the UE. In some embodiments, if a beam pair is supported, e.g., a combined beam BLER is supported, the candidate beam in q1 (to be measured) is measured as one pair. In some embodiments, if the number of beam pairs (N) is configured by RRC, 2N candidate beams (e.g., two candidate beams per beam pair) from available candidate beams are measured as pairs (e.g., each with a combined beam BLER), and the remaining/other beams (from the candidate beams) are individual candidate beams.

For example, if one (N=1) pair of beams is configured and (e.g., a total of) ten beams are configured as the candidate beams, two candidate beams are one pair and are measured with a combined BLER, and the other eight beams are measured as individual beams and each compared with the threshold.

For a new beam indication, in some embodiments, one new beam is indicated or reported (e.g., by the UE), and all of the CORESETs are associated with the new beam. In some embodiments, if SFN is configured for PDCCH transmission, two TCI states are activated for one CORESET, and if QCL type-D is configured in the TCI states, then there are two beams configured for the SFN-based CORESET. In some embodiments, if only one beam is indicated or reported (e.g., by the UE), then only one new beam is supported, and the SFN-based PDCCH is not supported, e.g., if only one new beam is indicated or reported (e.g., by the UE), the PDCCH is transmitted in a non-SFN manner.

If two beams are indicated, SFN-based PDCCH transmission and/or detection is supported. In some scenarios, not all the CORESETs in one bandwidth part are activated with two TCI states, and if two beams are indicated or reported, disclosed herein is how to use the two new beams associated with (each of) the CORESETs.

In some embodiments, all of the recovered links or CORESETs can use two beams irrespective of whether the two TCI states containing QCL type-D are supported for one/each CORESET or not. For example, if one link or CORESET is activated with one TCI state before beam failure recovery, the one link or CORESET can use the two beams after BFR, e.g., if two beams are indicated in the new beam indication, all of the CORESETs are SFN-based.

In some embodiments, a CORESET with two activated TCI states before beam failure can use the two indicated new beams or new beam pair, while a CORESET with only one activated TCI state before beam failure uses only one of the indicated new beam or new beam pair, and the number of new beams is associated with the index/identifier (ID) of the associated CORESET (CORESET ID). In some embodiments, one of the two beams is chosen/selected for the CORESET, and it can be configured by a higher layer parameter or as default, e.g., the first one of the two beams.

In some embodiments, one (e.g., best) beam pair and one (e.g., best) individual beam is reported or indicated. The CORESET(s) with two activated beams before beam failure can use the reported or indicated beam pair for (e.g., to allow) the CORESET to continue supporting two TCI states. In some embodiments, if the beam pair is measured as a group and may be not include the best beams for one beam transmission, then the individual beam is reported or indicated, and this individual beam is used for the CORESET(s) activated with one beam before beam failure.

In some embodiments, once the new beam indication is indicated or configured to the UE, the gNB uses the new beam based on the UE reporting. If two new beams are indicated, the two new beams are used for/in the link recovery, e.g., beam failure recovery. If a the UE can be provided a CORESET through a link to a SSS provided by recoverySearchSpaceId for monitoring PDCCH in the CORESET, then the CORESET is used to monitor a SFN-based PDCCH.

In some embodiments, if the UE is not provided pathlossReferenceRSs in PUCCH-PowerControl, is provided enableDefaultBeamPL-ForPUCCH, and is not provided PUCCH-SpatialRelationInfo, the default spatial relation or the default pathloss RS of PUCCH is associated with a CORESET with a lowest index on an active DL BWP.

In some embodiments, if the CORESET with a lowest index is activated with two TCI states, and PUCCH repetition is supported for the UL transmission, then the two TCI states of the CORESET with the lowest index are used on different PUCCH transmission occasions. In some embodiments, the CORESET with the lowest index is used on different PUCCH transmission occasions because all of the PUCCH transmission occasions are not transmitted to the same TRP, and the different TCI states are used on each occasion.

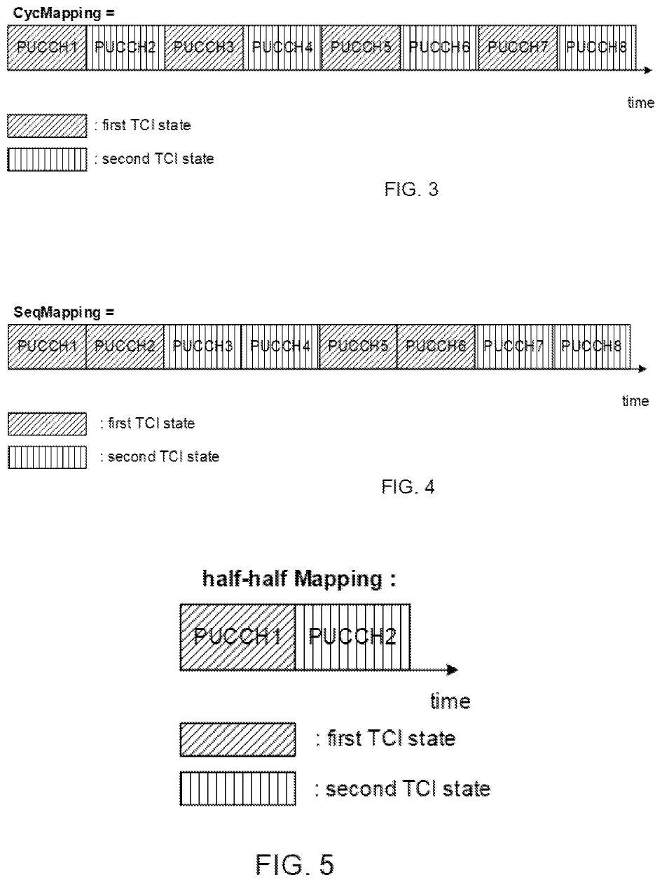

FIG. 3 illustrates an example diagram of cyclic mapping for a PUCCH transmissions, in accordance with some embodiments of the present disclosure. Some embodiments of a PUCCH transmission (e.g., for cyclic mapping or sequence mapping) have a repetition number of eight. Other repetition numbers are within the scope of the present disclosure. In some embodiments, for cyclic mapping, adjacent/contiguous PUSCH transmission occasions are associated with different default TCI states. For example, in some embodiments such as the one shown in FIG. 3, the PUCCH transmission occasions 1, 3, 5, 7 are associated with one of the default TCI states of the CORESET with the lowest index, and the PUCCH transmission occasions 2, 4, 6, 8 are associated with the other one of the default TCI states of the CORESET with the lowest index. Other occasion-default TCI state associations are within the scope of the present disclosure.

FIG. 4 illustrates an example diagram of sequence mapping for a PUCCH transmission, in accordance with some embodiments of the present disclosure. In some embodiments, for sequence mapping, first adjacent/contiguous PUSCH transmission occasions are associated with same default TCI states, and second adjacent/contiguous PUSCH transmission occasions are associated with different default TCI states. For example, in some embodiments such as the one shown in FIG. 3, the PUCCH transmission occasions 1, 2, 5, 6 are associated with one of the default TCI states of the CORESET with the lowest index, and the PUCCH transmission occasions 3, 4, 7, 8 are associated with the other one of the default TCI states of the CORESET with the lowest index. Other occasion-default TCI state associations are within the scope of the present disclosure.

FIG. 5 illustrates an example diagram of half-half mapping for PUCCH transmission, in accordance with some embodiments of the present disclosure. Some embodiments of PUCCH transmission (e.g., for half-half mapping) have a repetition number of eight for instance. Other repetition numbers are within the scope of the present disclosure. For half-half mapping, each repetition is associated with one TCI state. For example, in some embodiments such as the one shown in FIG. 5, the PUCCH transmission occasion 1 is associated with one of the default TCI states of the CORESET with the lowest index, and the PUCCH transmission occasion 2 is associated with the other one of the default TCI states of the CORESET with the lowest index.

In some embodiments, for PUCCH repetition transmission, if different TCI states can be used for different PUCCH repetition occasions, then the lowest indexed CORESET is activated with two TCI states, or the default TCI state for PUCCH repetition is the CORESET with the lowest index that is activated with two TCI states.

In some embodiments, for physical uplink shared channel (PUSCH) repetition type A, the default TCI state or the default pathloss RS of PUSCH is the TCI state activated for the lowest indexed CORESET, and the PUSCH repetition mapping includes at least one of sequence mapping, cyclic mapping, or half-half mapping. In some embodiments, the two TCI states of the CORESET with the lowest index can be used for different PUSCH repetition occasions.

For codebook-based PUSCH transmission, two sounding reference signal (SRS) resources or resource sets can be indicated to the UE. In some embodiments, if the spatial relation or pathloss RS is not configured for SRS, the default pathloss RS(es) is/are the RS(es) contained in the CORESET with the lowest index. In some embodiments, if the CORESET is activated with two TCI states, the RS(es) in the two TCI states can be used as the default pathloss RS(es) of the two SRS resource sets, and the two TCI states of the CORESET are associated with different SRS resource sets. But, in some embodiments, if the activated downlink bandwidth part is not configured with CORESET, the default pathloss RS(es) of the two SRS resource sets can be associated with the RS(es) in the two TCI states of the codepoint with the lowest index, and the two TCI states of the codepoint are associated with different SRS resource sets.

Each of the two groups of transmission occasions for PUCCH repetition or PUSCH repetition can be associated with at least one of: an SRS resource set; a SRS resource; a spatial relation; a TCI state; a PUSCH frequency hop; QCL information; or a set of power control parameters.

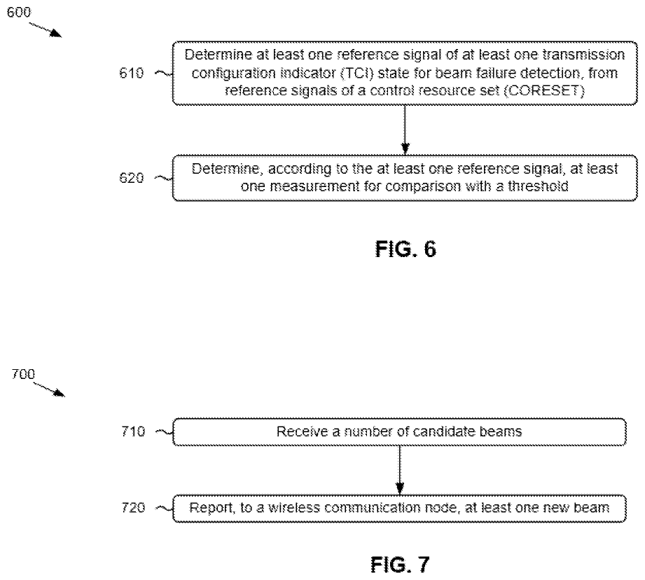

FIG. 6 illustrates a flowchart diagram of a method 600 for beam failure recovery, in accordance with some embodiments of the present disclosure. Referring to FIGS. 1-5, the method 600 can be performed by a wireless communication device (e.g., UE) and/or a wireless communication node (e.g., base station), in some embodiments. Additional, fewer, or different operations may be performed in the method 600 depending on the embodiment.

In brief overview, in some embodiments, a wireless communication device determines at least one reference signal of at least one transmission configuration indicator (TCI) state for beam failure detection, from reference signals of a control resource set (CORESET) (operation 610). The wireless communication device determines, according to the at least one reference signal, at least one measurement for comparison with a threshold (operation 620).

In more detail, at operation 610, in some embodiments, a wireless communication device determines at least one reference signal of at least one transmission configuration indicator (TCI) state for beam failure detection, from reference signals of a control resource set (CORESET). In some embodiments, the reference signals of the CORESET activated with two TCI states indicate a single frequency network (SFN) scenario or configuration. In some embodiments, the at least one reference signal is a reference signal resource, a reference signal resource set, a reference signal resource pair, or a reference signal resource set pair. In some embodiments, the CORESET is activated with two TCI states.

In some embodiments, the at least one reference signal determined for beam failure detection includes one reference signal of one of the two (e.g., activated) TCI states that has a higher reference signal received power (RSRP) or signal-to-interference and noise ratio (SINR) than another one of the other one of the two TCI states, includes quasi co-location (QCL) assumption of Doppler shift or delay information, is configured via radio resource control (RRC) or medium access control control element (MAC CE) signaling for beam failure detection, or is predetermined from a default TCI state (e.g., identified/configured for beam failure detection).

In some embodiments, the at least one reference signal is from: the two TCI states of the CORESET activated with the two TCI states, TCI states selected according to an order of indices (ID) of CORESETs, TCI states selected according to an order of RSRP values, or TCI states of the CORESETs, selected according to size of periods of channel state information reference signal (CSI-RS) or synchronization signal block (SSB).

At operation 620, in some embodiments, the wireless communication device determines, according to the at least one reference signal, at least one measurement for comparison with a threshold. In some embodiments, the measurement includes at least one of a block error rate (BLER), RSRP, or SINR.

In some embodiments, the at least one reference signal determined for beam failure detection includes reference signals of the two TCI states, and the at least one measurement includes at least one of an individual measurement or a combined measurement. For example, in some embodiments, the at least one reference signal includes one individual measurement and one combined measurement for one CORESET. In some embodiments, the at least one reference signal includes two individual measurements for one CORESET. In some embodiments, the at least one reference signal includes two individual measurements and one combined measurement for one CORESET. In some embodiments, the combined measurement is used to measure a reference signal resource pair, or a reference signal resource set pair.

In some embodiments, the individual measurement is one of two measurements that are each determined for a respective reference signal associated with a respective one of the two TCI states, wherein the respective reference signal has a higher RSRP or SINR than another reference signal of the other one of the two TCI states, includes QCL assumption of Doppler shift or delay information, is configured via RRC or MAC CE signaling for beam failure detection, or is predetermined from a default TCI state for beam failure detection.

In some embodiments, the combined measurement includes a smaller one of two measurements, an average or mean of the two measurements, or a weighted combination of the two measurements. In some embodiments, the weighted combination of the two measurements is a combination according to a ratio of RSRP or SINR of the two measurements. In some embodiments, whether the at least one measurement includes the individual measurement or the combined measurement, is configured via RRC signaling.

In some embodiments, the at least one measurement includes the combined measurement, and is according to physical downlink control channel (PDCCH) transmission assumptions for an SFN. In some embodiments, the PDCCH transmission assumptions for SFN includes: a power boosting of ratio of hypothetical PDCCH resource element (RE) energy to average search space set (SSS) RE energy, a power boosting of ratio of hypothetical PDCCH demodulation reference signal (DMRS) energy to average SSS RE energy, and/or a parameter set for SFN PDCCH transmission.

FIG. 7 illustrates a flowchart diagram of a method 700 for introducing or adding new beam(s), in accordance with some embodiments of the present disclosure. Referring to FIGS. 1-5, the method 700 can be performed by a wireless communication device (e.g., UE) and/or a wireless communication node (e.g., base station), in some embodiments. Additional, fewer, or different operations may be performed in the method 700 depending on the embodiment.

In brief overview, in some embodiments, the wireless communication device receives a number of candidate beams (operation 710). In some embodiments, the wireless communication device reports, to a wireless communication node, at least one new beam (at operation 720).

In more detail, at operation 710, in some embodiments, the wireless communication device receives a number of candidate beams. In some embodiments, a number of beam pairs (e.g., pairs of beams) to be measured (N) is configured via radio resource control (RRC) signaling, and formed from 2N (number) of the candidate beams, and a remainder of the candidate beams are to be individually measured.

At operation 720, in some embodiments, the wireless communication device reports, to a wireless communication node, at least one new beam. In some embodiments, the at least one new beam is associated with at least one reference signal resource or reference signal resource set. In some embodiments, the wireless communication device reports or indicates, to the wireless communication node, only one new beam, and can cause a physical downlink control channel (PDCCH) to be transmitted in a non-single frequency network (SFN) manner.

In some embodiments, the wireless communication device reports, to the wireless communication node, two new beams as a beam pair. In some embodiments, each link or control resource set (CORESET) after beam failure recovery uses the two new beams regardless of whether the respective CORESET supports two TCI states prior to the beam failure recovery. In some embodiments, each CORESET having two TCI states prior to the beam failure recovery, can use the two new beams after the beam failure recovery, and each CORESET having one TCI state prior to the beam failure recovery, can use one of the two new beams after the beam failure recovery. In some embodiments, a CORESET for linking to a search space set, uses the two new beams (e.g., two new TCI states).

In some embodiments, the wireless communication device reports, to the wireless communication node, two new beams as a beam pair, and a new individual beam, wherein each CORESET having two TCI states prior to the beam failure recovery, can use the beam pair after the beam failure recovery, and each CORESET having one TCI state prior to the beam failure recovery, can use the new individual beam after the beam failure recovery.

In some embodiments, the wireless communication device determines, according to the at least one reference signal corresponding to the at least one beam, at least one measurement for comparison with a threshold. In some embodiments, the measurement includes at least one of a block error rate (BLER), reference signal received power (RSRP), or signal-to-interference and noise ratio (SINR).

In some embodiments, the at least one reference signal includes one reference signal of a first beam that: has a higher RSRP or SINR than another reference signal of another beam, includes QCL assumption of Doppler shift or delay information, is configured via RRC or MAC CE signaling, and/or is predetermined from a default beam.

In some embodiments, the at least one reference signal includes reference signals of two new beams, and the at least one measurement includes at least one of an individual measurement or a combined measurement.

In some embodiments, the individual measurement is one of two measurements that are each determined for a respective reference signal associated with a respective one of the two beams, wherein the respective reference signal: has a higher RSRP or SINR than another reference signal of another one of the two beams, includes QCL assumption of Doppler shift or delay information, is configured via RRC or MAC CE signaling, and/or is predetermined from a default beam.

In some embodiments, the combined measurement includes: a smaller one of two measurements, an average or mean of the two measurements, or a weighted combination of the two measurements. In some embodiments, the weighted combination of the two measurements is a combination according to a ratio of RSRP or SINR of the two measurements. In some embodiments, whether the at least one measurement includes the individual measurement or the combined measurement, is configured via RRC signaling.

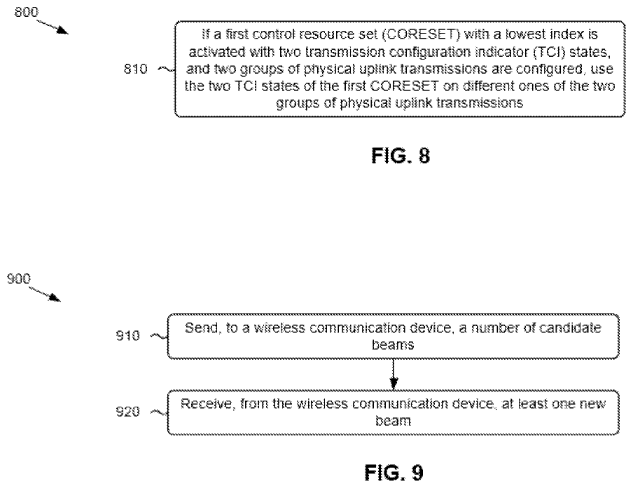

FIG. 8 illustrates a flowchart diagram of a method 800 for using TCI state(s) for uplink transmission(s), in accordance with some embodiments of the present disclosure. Referring to FIGS. 1-5, the method 800 can be performed by a wireless communication device (e.g., UE) and/or a wireless communication node (e.g., base station), in some embodiments. Additional, fewer, or different operations may be performed in the method 800 depending on the embodiment.

At operation 810, in some embodiments, if a first control resource set (CORESET) with a lowest index is activated with two transmission configuration indicator (TCI) states, and two groups of physical uplink transmissions are configured, a wireless communication device uses the two TCI states of the first CORESET on different ones of the two groups of physical uplink transmissions. In some embodiments, the two TCI states of the first CORESET on different ones of the two groups of physical uplink transmissions include the information at least one of spatial relations of the reference signal of the two TCI states; a set of power control parameters; or pathloss related information.

In some embodiments, the two groups of physical uplink transmissions include at least one of two groups of transmission occasions for physical uplink control channel (PUCCH); two groups of transmission occasions for physical uplink shared channel (PUSCH); or two sounding reference signal (SRS) resource sets. In some embodiments, each group of physical uplink transmission associated with at least one of: a SRS resource set; a SRS resource; a spatial relation; a TCI state; a transmission frequency hop; quasi co-location (QCL) information; or a set of power control parameters. In some embodiments, default TCI states for the two groups of the physical uplink transmission should be from the first CORESET with the lowest index, or from the first CORESET with the highest index.

FIG. 9 illustrates a flowchart diagram of a method 900 for introducing or adding new beam(s), in accordance with some embodiments of the present disclosure. Referring to FIGS. 1-5, the method 900 can be performed by a wireless communication device (e.g., UE) and/or a wireless communication node (e.g., base station), in some embodiments. Additional, fewer, or different operations may be performed in the method 900 depending on the embodiment.

In brief overview, in some embodiments, a wireless communication node sends, to a wireless communication device, a number of candidate beams (operation 910). In some embodiments, the wireless communication node receives, from the wireless communication device, at least one new beam (at operation 920).

In more detail, at operation 910, in some embodiments, a wireless communication node sends/indicates/configures, to a wireless communication device, a number of candidate beams. In some embodiments, a number of beam pairs to be measured (N) is configured via radio resource control (RRC) signaling, and can be formed from 2N number of the candidate beams, and a remainder of the candidate beams are to be individually measured.

At operation 920, in some embodiments, the wireless communication node receives, from the wireless communication device, at least one new beam. In some embodiments, the at least one new beam is associated with at least one reference signal resource or reference signal resource set.

In some embodiments, a non-transitory computer readable medium stores instructions, which when executed by at least one processor, cause the at least one processor to perform any of the methods described above. In some embodiments, an apparatus includes at least one processor configured to implement any of the methods described above.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method, comprising:
determining, by a wireless communication device, two reference signals of two transmission configuration indicator (TCI) states for beam failure detection, from reference signals of a control resource set (CORESET); and
determining, by the wireless communication device according to the two reference signals, at least one measurement for comparison with a threshold, the at least one measurement comprising a combined measurement for the two TCI states.

2. The method of claim 1, wherein the CORESET is activated with the two TCI states.

3. The method of claim 1, wherein the combined measurement comprises:
a block error rate (BLER).

4. The method of claim 1, wherein the combined measurement is according to physical downlink control channel (PDCCH) transmission assumptions for single frequency network (SFN).

5. A wireless communication device, comprising:
at least one processor configured to:
determine two reference signals of two transmission configuration indicator (TCI) states for beam failure detection, from reference signals of a control resource set (CORESET); and
determine, according to the two reference signals, at least one measurement for comparison with a threshold, the at least one measurement comprising a combined measurement for the two TCI states.

6. The wireless communication device of claim 5, wherein the CORESET is activated with the two TCI states.

7. The wireless communication device of claim 5, wherein the combined measurement comprises a block error rate (BLER).

8. The wireless communication device of claim 5, wherein the combined measurement is according to physical downlink control channel (PDCCH) transmission assumptions for single frequency network (SFN).

9. A non-transitory computer readable storage medium storing instructions, which when executed by one or more processors can cause the one or more processors to:
determine two reference signals of two transmission configuration indicator (TCI) states for beam failure detection, from reference signals of a control resource set (CORESET); and
determine, according to the two reference signals, at least one measurement for comparison with a threshold, the at least one measurement comprising a combined measurement for the two TCJ states.

10. The non-transitory computer readable storage medium of claim 9, wherein the CORESET is activated with the two TCJ states.

11. The non-transitory computer readable storage medium of claim 9, wherein the combined measurement comprises a block error rate (BLER).

12. The non-transitory computer readable storage medium of claim 9, wherein the combined measurement is according to physical downlink control channel (PDCCH) transmission assumptions for single frequency network (SFN).
